(19) United States
(12) Patent Application Publication
(10) Pub. No.: US 2010/0113138 A1
(43) Pub. Date: May 6, 2010

(54) PROVIDING ALTERNATIVE GAMING PAYOUTS

(75) Inventors: Anthony J. Baerlocher, Reno, NV (US); Daniel J. DeWaal, Las Vegas, NV (US)

Correspondence Address: Armstrong Teasdale LLP (IGT - 26668);Robert B. Reeser, III, One Metropolitan Square, Suite 2600, St. Louis, MO, 63102, US

(73) Assignee: IGT, Reno, NV (US)

(21) Appl. No.: 12/264,820

(22) Filed: Nov. 4, 2008

(51) Int. Cl. A63F 9/24; A63F 13/00

(52) U.S. Cl. 463/25

(57) ABSTRACT

An apparatus is provided including a display unit configured to provide game images to a player, an input unit for receiving a wager from a player, a memory area for storing a threshold value and a processor coupled to the display, input unit and memory area. The processor is programmed to control a game for display to the player, determine the outcome of a game, determine the payout value based at least partially on a wager placed by the player, compare the determined payout value with the threshold value and determine a plurality of payout options where at least one of the options includes a cash payout less than the threshold value. Embodiments of the invention may reduce a player's tax liability, attract players to a particular machine, attract repeat players, and enable a gaming operator to offset a cash payout by offering non-cash prizes.

### BACKGROUND

Gaming establishments provide players the ability to place a wager in exchange for the opportunity to receive some sort of payout win for the wager. Players who play higher denominations, such as five dollars ($5), have a tendency to desire higher payouts and risks than those players playing lower denominations, such as a nickel (5 cents). In one aspect, current tax laws related to gaming require that any win over $1200 be reported on a W2G form and noted on the winning players' income tax return as income. For example, winning an automobile on a slot machine generates taxable income to the player. This often entails locking the machine up and having a gaming employee obtain the player's identification and address information for tax purposes before providing the payout. This is a time consuming process that is not desirable for either the player or the gaming establishment.

Some gaming establishments offer point play. Point play allows users to exchange winnings for credits for further play. This provides higher returns, provides cost savings to the gaming establishment, and enhances player loyalty. However, such programs do not enable the player to exchange the winnings for other prizes.

### BRIEF DESCRIPTION

Embodiments of the invention enable a gaming machine to determine a plurality of payout options. A threshold value is predetermined and/or altered dependent on data contained on a player's card. The player makes a wager and a game is controlled by a computing device. A payout dependent on the wager and outcome of the game is determined and compared against the threshold value. If the determined payout is greater than the threshold value, a plurality of payout options are determined where at least one has a cash payout less than the threshold value. In some embodiments, the plurality of payout options are displayed to the player and the player selects one of the payout options.

Benefits of providing a plurality of payout options are: reduction of tax liability to the player, enticements for player's to play a particular gaming machine, repeat players based on defining preferences on their player's card, and many more that one of ordinary skill in the art would determine. Furthermore, gaming operator may offset some of their cash payouts by providing equivalent value in merchandise, lodging, show tickets, airplane vouchers, gaming credits, gaming tokens, and other options as determined by the gaming operator.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter

### BRIEF DESCRIPTION OF THE DRAWINGS

FIG. 1 is a schematic diagram of an exemplary gaming machine;

FIG. 2 is a block circuit diagram of an exemplary architecture incorporated into the gaming machine shown in FIG. 1.

FIG. 3 is a block diagram of an exemplary gaming network utilizing an Ethernet hub and bank controllers;

FIG. 4 is a block diagram of an exemplary gaming network utilizing a central gaming network controller;

FIGS. 5A, 5B and 5B are flowcharts illustrating exemplary methods for determining a plurality of payout values of a gaming machine; and

FIGS. 6A and 6B are flowcharts illustrating exemplary methods for determining and displaying a plurality of payout values of a gaming network.

### DETAILED DESCRIPTION

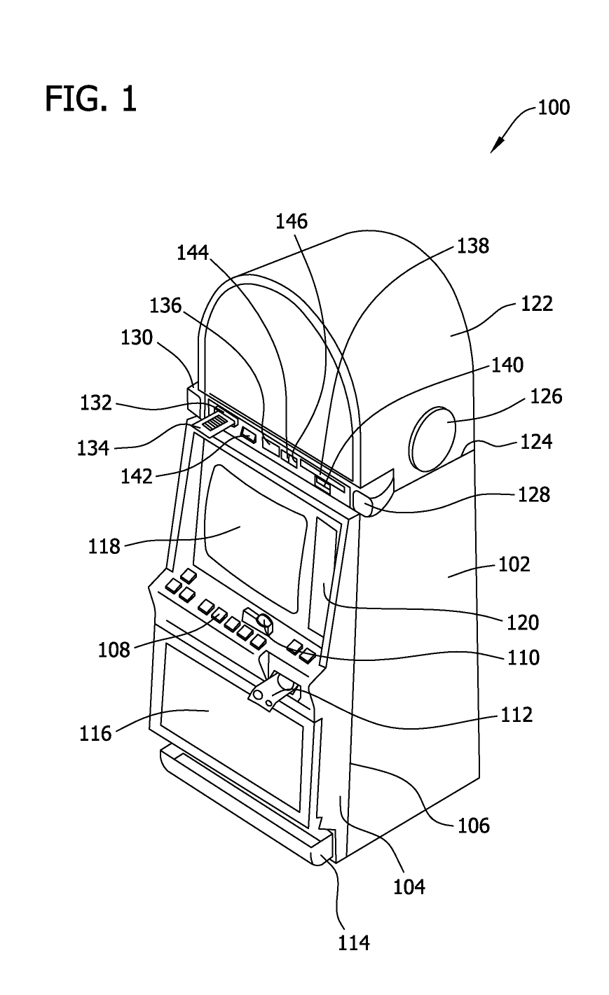

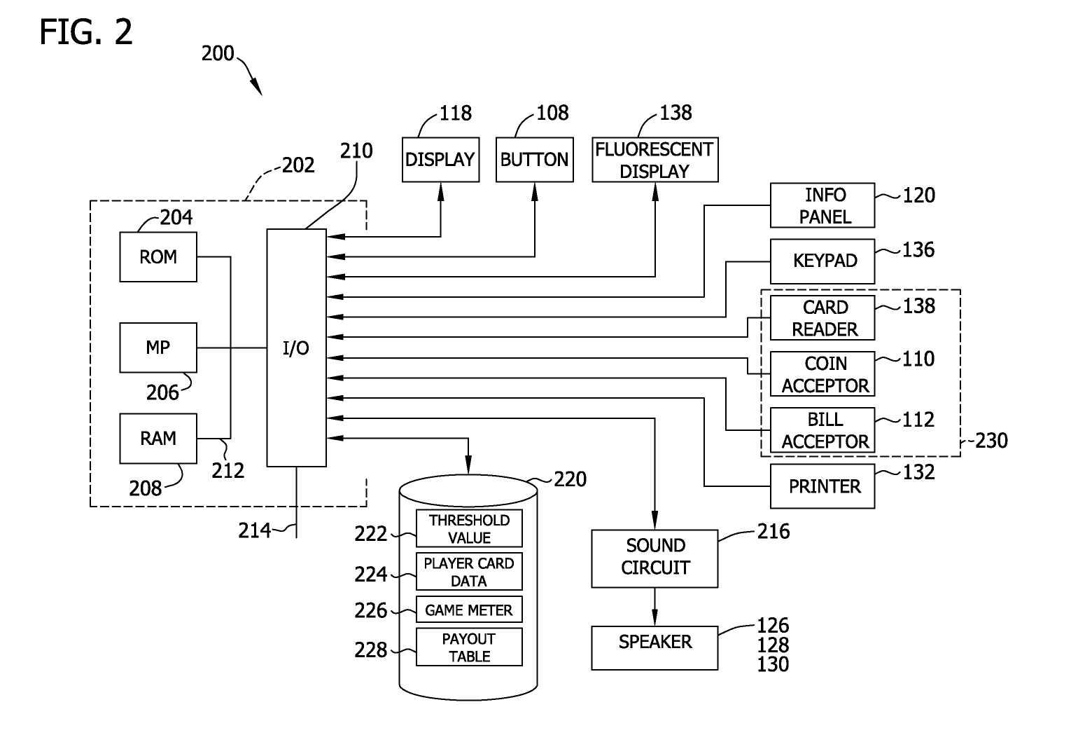

Embodiments of the invention enable a gaming machine and/or gaming network to determine a plurality of payout options where at least one of the plurality of payout options has a cash value less than a threshold value. The payout options are determined based on at least a wager and a payout table where the determined payout exceeds the threshold value as determined by the gaming operator, player, and/or the gaming house as described in FIG. 2. The threshold value may be set using a player's card data, a tax liability value, a house limit, or any other means determined by the gaming operator, player, and/or gaming house. In some embodiments, the player is presented with the payout options and the player selects one of the plurality of payout options. Aspects of the invention may be implemented with a device such as gaming machine shown in FIG. 1.

Referring to FIG. 1, an exemplary schematic diagram illustrates a gaming machine 100 that includes a gaming machine which may be used to determine and display a plurality of payout options based on the outcome of a game played on the gaming machine. Gaming machine 100 may be any type of gaming machine, and may include different structures than those shown in FIG. 1. Moreover, gaming machine 100 may employ different methods of operation than those described below.

In the exemplary embodiment, gaming machine 100 includes a main cabinet 102 having a main door 104 hingedly coupled to a front 106 of gaming machine 100. When opened, door 104 provides access to an interior of gaming machine 100. In the exemplary embodiment, pluralities of player-input switches and/or buttons 108 are coupled to main door 104. Moreover, in the exemplary embodiment, a coin acceptor 110, for accepting coins and/or tokens, a bill acceptor 112, for accepting and/or validating cash bills, a coin tray 114, for collecting a coin-based payout, and a belly glass 116 are each coupled to main door 104. A video display monitor 118 and an information panel 120 are viewable through main door 104. Video display monitor 118 may be implemented as a cathode ray tube (CRT), a flat-panel liquid crystal display (LCD), a plasma display, an organic light-emitting diode (OLED) display, or any other electronically-controlled video monitor. In another embodiment, the gaming machine 100 includes mechanical reels for displaying the game. Moreover, video display monitor 118 may include touch screen capabilities. In the exemplary embodiment, information panel 120 is a back-lit, silk screened glass panel that includes lettering to indicate general game information including, for example, a number of coins wagered. Coin acceptor 110, bill acceptor 112, player-input buttons 108, video display monitor 118, and information panel 120 are each used by a player to play a game on gaming machine 100. Each component 108, 110, 112, 118, and/or 120 is controlled by a gaming machine controller (not shown in FIG. 1) that is housed inside main cabinet 102. Numerous games including, but not limited to only including, video slot games, video poker, video pachinko, video black jack, video card games, and/or video keno may be implemented for play on gaming machine 100.

In the exemplary embodiment, gaming machine 100 also includes a top box 122 that is positioned on a top surface 124 of main cabinet 102. In the exemplary embodiment, top box 122 includes a number of devices that may be used to add features to a game being played on gaming machine 100. Such devices may include, but are not limited to only including, speakers 126, 128, and 130, a ticket printer 132 for printing bar-coded tickets 134, a key pad 136 for entering player tracking information, or player preferences or characteristics, a florescent display 138 for displaying player tracking information and/or player preferences or characteristics, and a card reader 140 for receiving a magnetic striped card containing player tracking information and/or player preferences or characteristics encoded thereon. Card reader 140 may also be used to accept coupons, credit cards, debit cards, private house cards, printed cards, smart cards, and/or ticket vouchers. Moreover, top box 122 may house additional devices not shown in FIG. 1, such as, for example, a bonus wheel, a secondary video display, and/or a back-lit silk screened panel that may be used to add bonus features to a game being played on gaming machine 100. During game play, such devices may be controlled by circuitry, such as the gaming machine controller housed within main cabinet 102.

Referring now to FIG. 2, an exemplary block circuit diagram illustrates an exemplary electrical architecture 200 incorporated into an exemplary gaming machine, such as gaming machine 100. In the exemplary embodiment, gaming machine 100 includes a gaming machine controller 202 that includes a read-only memory (ROM) 204, a microcontroller or microprocessor (MP) 206, a random-access memory (RAM) 208, and an input/output (I/O) circuit 210, each coupled via an address/data bus 212. As used herein, the terms “controller” and “processor” may include any programmable system including systems using microcontrollers, reduced instruction set circuits (RISC), application specific integrated circuits (ASICs), logic circuits, and any other circuit or processor capable of executing the functions described herein. The above examples are exemplary only, and are thus not intended to limit in any way the definition and/or meaning of the terms “controller” or “processor”.

Alternative embodiments of controller 202 may include more than one microprocessor 206, multiple RAM modules 208, and/or multiple ROM modules 204. Moreover, although I/O circuit 210 is shown in FIG. 2 as a single component, one of ordinary skill in the art will appreciate that I/O circuit 210 may include any number or a plurality of different types of I/O circuits. Further, RAM 208 and/or ROM 204 may be implemented as, for example, semiconductor memories, magnetically readable memories, and/or optically readable memories. In one embodiment, each operational component of gaming machine 100 is coupled to I/O circuit 210 via a respective conductor. Alternative embodiments may include a single coupling between the operational components of gaming machine 100 and I/O circuit 210. In the exemplary embodiment, I/O circuit 210 is coupled to a gaming network (not shown) via a network interface 214.

Moreover, in the exemplary embodiment, architecture 200 includes a sound circuit 216 that generates audio signals and that communicates the audio signals between I/O circuit 210 and speakers 126, 128, and/or 130. Further, the gaming machine controller 202 is coupled to a memory area 220, such as, for example, a database. The memory area 220 is configured to store data in regards to the game machine and player information such as, for example, a threshold value 222, player card information 224, a game meter 226 for storing the number of wins at the gaming machine 100, a payout table, and any other data that an operator desires to store at the memory area 220. As used herein, a value input interface 230 may include the coin acceptor 110, the bill acceptor 112, the card reader 140 and any other input device capable of executing the functions described herein.

In an exemplary embodiment, the gaming machine controller 202 displays game images and/or video to the video display monitor 118 of gaming machine 100. Gaming machine controller 202 receives input from a player at the value input interface 230; the gaming machine controller 202 may display to the player a request to input a wager amount and/or amounts of a wager to choose. The player selects the wager amount using the key pad 136 or any other mechanism to indicate a selection.

The threshold value 222 bonus or progressive flag is associated with the payout tables 228 stored in the memory area 220 coupled to the gaming machine controller 202. The payout tables 228 include at least a payout table, but may also include at least one alternative payout table. The gaming machine controller 202 may further store data from the player's card. A game is displayed at the video display monitor 118 by the gaming machine controller 202. The gaming machine controller 202 determines an outcome and based at least partially on the wager determines a payout based on the payout tables 228 stored in the memory area 220 of gaming machine controller 202.

When the gaming machine controller 202 determines that the payout is greater than the threshold value 222, the payout is altered in the payout tables 228 associated with the wager by a secondary pay table. This pay table can reside in the main games processor or on a remote server. Although the following examples present a progressive interrupt flag associated with a payout table, other methods to determine the threshold value 222 may be implemented by a gaming operator such as, for example, data stored on a player's card, a predetermined threshold stored in a memory area such as a house limit, tax liability amount or any value determined by the gaming operator, player or gaming vendor, or any other method that may be supported by the system. It should be appreciated that the payout need not be a progressive, but the payout tables 228 of any payout associated with a wager of a specific amount may be altered in the manner described herein. In one embodiment, the payout tables 228 are modified so that a number of different progressive levels may be defined. The defined progressive levels are set based on the wager. That is, if a determined payout results in a win over the threshold value 222, for example, a taxable amount, its modified entry in the payout tables 228 will be set. If the modified payout tables 228 are set for the payout, a flag will be sent to the gaming machine controller 202 when the payout combination is hit.

Some embodiments allow for a progressive interrupt flag to alter any determined payout greater than the threshold value 222. In another embodiment, the gaming machine controller 202 only pays a higher payout when a progressive level is achieved by the player. Once the interrupt occurs, a type of bonus game may be presented to the player which has a determined payout equal to or greater than the threshold value 222, but yields payouts that range from below the determined payout value to above the determined payout value in order to move a larger percentage of payouts into the non-taxable area and provide much larger payouts for those that are taxable or to create a higher volatility.

When the progressive flag is sent to the gaming machine controller 202 to indicate a payout has been hit, the game receives a “0” pay and the gaming machine controller 202 (or remote gaming server 310 in a server-based embodiment) reads the progressive level and determines a plurality of payout options. For example, the player may select one of the plurality of payout options, but it is not reported to the game. If the selected one of the plurality of payout options results in a taxable payout, a W2G will still need to be processed. Otherwise, play may continue as normal.

In one embodiment, the gaming machine 100 may mark any number of combinations as a threshold payout by identifying the combination with the progressive flag. The following is an exemplary break down of payout amounts with possible progressive flags for the denominations of $5, $10, $25, and $100.

TABLE 1
Exemplary Payout Table.

| Credit | Progressive | | | | |
|---|---|---|---|---|---|
| Win | Flag | $5 | $10 | $25 | $100 |
| <20 | | | | | |
| 20 | P8 | $100 | $200 | $500 | $2,000 |
| 40 | P7 | $200 | $400 | $1,000 | $4,000 |
| 50 | P6 | $250 | $500 | $1,250 | $5,000 |
| 80 | P6 | $400 | $800 | $2,000 | $8,000 |
| 100 | P5 | $500 | $1,000 | $2,500 | $10,000 |
| 160 | P4 | $800 | $1,600 | $4,000 | $16,000 |
| 200 | P4 | $1,000 | $2,000 | $5,000 | $20,000 |
| 320 | P3 | $1,600 | $3,200 | $8,000 | $32,000 |
| 640 | P2 | $3,200 | $6,400 | $16,000 | $64,000 |
| 1600 | P1 | $8,000 | $16,000 | $40,000 | $160,000 |

When a player is wagering high limits, they are likely to see a payout equal to or exceeding a taxable value. Embodiments of the present invention allows for the progressive interrupt flags to be set when a payout is equal to or greater than a taxable event. In the above illustration, the flags are enabled as follows:

TABLE 2
Exemplary Setting of the Progressive Flag.

| Wager Amount | Progressive Flag(s) Set |
|---|---|
| $5 | P1, P2, and P3 |
| $10 | P1, P2, P3, and P4 |
| $25 | P1, P2, P3, P4, P5, and P6 |
| $100 | P1, P2, P3, P4, P5 P6, P7, and P8 |

Using the information, the game designer may implement a variable pay model for the progressive events. In this model, the goal is to offer a larger number of $1000 payouts (non taxable cash payouts) and a few larger payouts so that the average payback equals the expected progressive amount. That is, the actual payout amount may not be provided to the player, but payout options ranging from lower than the determined payout to higher than the determined payout are available and weighted in such a manner that the average payout is equal to the determined payout.

For instance, referencing the chart above, P7 has a normal payout of 40 coins. The $5, $10, and $25 denominations, this does not result in a payout equal to or in excess of taxable value, where the taxable value is $1200. However, for the $100 denomination, the determined payout is $4000 and is thus taxable. Therefore, the P7 progressive interrupt is set for the $100 denomination and anytime the payout triggers, the gaming system will set the progressive interrupt flag. When the progressive interrupt flag is set, the system may enable any type of bonus game to be provided. In the following example, a “pick one” bonus game is provided to the player when the progressive interrupt flag is set.

TABLE 3
Payout Table with Bonus Game Altering Payout.

| Pay | ($ Value) | Times | Probability | Contribution |
|---|---|---|---|---|
| 5 | $500 | 3 | 7.50% | 0.38 |
| 8 | $800 | 8 | 20.00% | 1.60 |
| 10 | $1,000 | 10 | 25.00% | 2.50 |
| 11 | $1,100 | 11 | 27.50% | 3.03 |
| 50 | $5,000 | 2 | 5.00% | 2.50 |
| 100 | $10,000 | 3 | 7.50% | 7.50 |
| 200 | $20,000 | 2 | 5.00% | 10.00 |
| 500 | $50,000 | 1 | 2.50% | 12.50 |
| | | | | 40.00 |

As is shown above, even though the determined payout is expected to be $4000 a number of different payout options are offered that range from $500 up to $50,000 with the average expected payout being equal to 40 coins (or $4000 for the $100 denomination). By using this model, a number of lower paying non-taxable payouts are offered to the player as well as some much higher payouts than would otherwise be available. In this example, 80% of the payouts are moved into the non-taxable range and the taxable payouts are more substantial (such as, in this example, ranging from $5000 up to $50,000).

In another embodiment, a split pay model is used when the progressive flag interrupt occurs by offering the player promotional (non-cashable) credits as part of the win. When a determined payout is over the threshold value 222 a message is sent to the gaming machine controller 202 which splits the win into a partial cash payout and a partial promotional credit pay to the player account. For instance, if a determined payout is associated with 100 coins, it is set for the $25 and $100 denominations (as both results in taxable wins). If the payout were to occur at the $25 denomination, it could pay $1175 in cash or credits and $1325 in promotional credits allowing the payout to remain in the non-taxable range. Likewise, if it were to occur at the $100 denomination, it could pay $1100 in cash or credits and $8900 in promotional credits. The operator may adjust the payout such as, for example, adjusting the promotion credits to a higher value to give a perceived advantage to the player, such as adjusting the value to $9,000 in the later example. This provides a higher return to the player. This embodiment allows for the progressive interrupt flag to split a determined payout equal to or greater than a taxable value in a manner that no longer makes it taxable by offering the player promotional credits as part of the win.

In yet another embodiment, an alternative prize model is used when a progressive interrupt occurs. When a determined payout over the threshold value 222 occurs, a message is sent to the gaming machine controller 202 where players are provided payout options that include, for example, merchandise or resort amenities. Cash prizes are able to be exchanged for player points or gift shopping points. The selected alternative payouts may be stored on the player's card, a certificate produced at the gaming machine, or any other method to provide the payout to the player. Further, the payout option could be combined with split pay such that a player may receive $1000 cash and the rest could be paid in amenities of the player's choice. This embodiment allows for the progressive flag to split a taxable payout in a manner that no longer makes it taxable by offering the player promotional credits as part of the win.

In another embodiment, the player may choose how their win is to be paid, such as, for example, selecting the determined payout, selecting an payout option paying part cash and part promotional, selecting an all promotional payout, selecting a part cash, part merchandise payout, selecting an all merchandise payout, determined by data stored on a player's card, or in any other manner supported by the system.

By providing the progressive flag or other flag to interrupt the game, the gaming system has the capability to alter payouts such that taxable payouts occur less frequently, but the overall payback percentage associated with the game is not changed. This allows for a wider range of prizes to be presented to the player wherein any taxable payouts are much more substantial and non-taxable payouts occur more frequently. Further, a player may be provided with options on how they wish to be paid.

Aspects of the disclosure are not limited to the progressive flag described herein. Other embodiments contemplate that any flag or other trigger will pause game play and provide the player with alternative pay options.

After the payout options have been determined, processor displays the options to the player at the video display monitor. The player selects a choice of the plurality of payout options using the player input device. The payout is then dispensed, a certificate is dispensed to the user for redemption at a payout window, or the player receives the payout in some other manner.

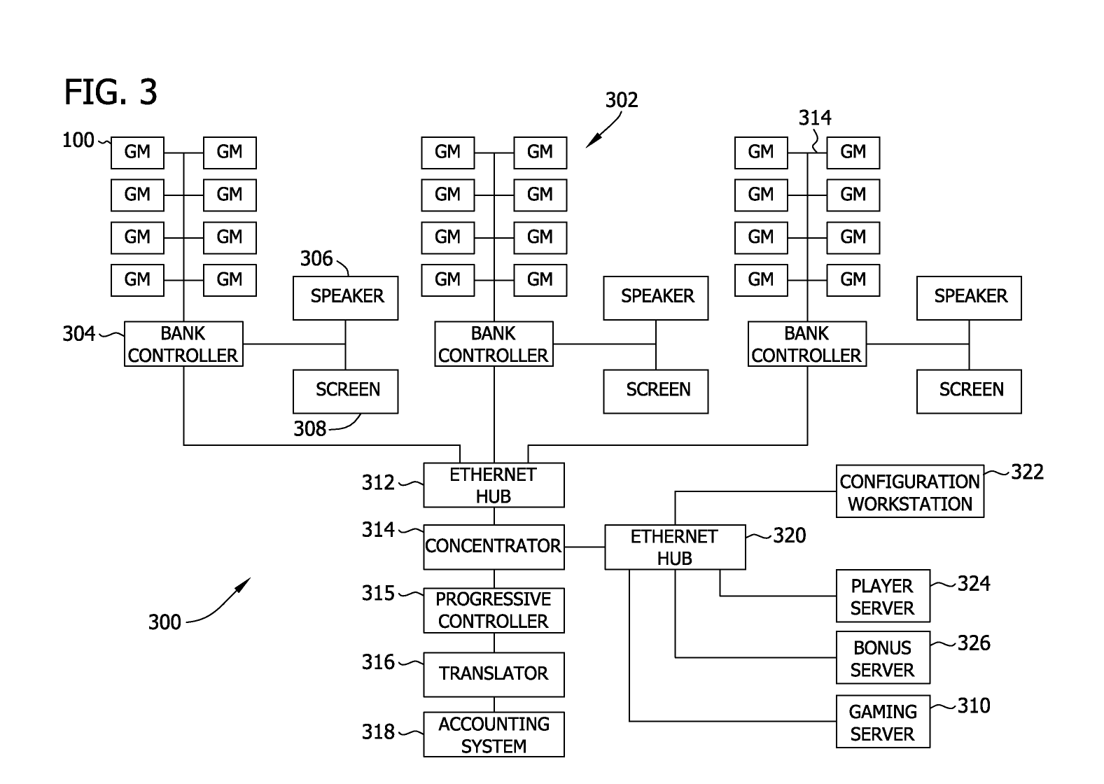

Referring now to FIG. 3, in one embodiment, an exemplary block diagram illustrates a gaming network 300 that includes a plurality of gaming machines 100. A gaming network is also referred to as Server based gaming which is a technology that allows elements of the gaming experience to be configurable based upon a variety of factors. The games could be configurable by a supplier, by a player, or by the operator. This configurability provides a dynamic flexibility that allows greater control of not only how the game plays, but also how the game interacts within the system and how it looks and feels to the player. Server based gaming has a wide variety of applications and uses in the gaming field. Server based gaming has also provided the ability to incorporate a service window (e.g., a mobile service window) into the main game window to provide information and/or further gaming opportunities to the player.

In this example of FIG. 3, three banks 302 of gaming machines 100 are coupled preferably by an Ethernet. In other embodiments, the gaming machines 100 are coupled using non-Ethernet, private networks, and combinations of networking types. Each gaming machine 100 is coupled via a network connection 214 to a bank controller 304. In one embodiment, each bank controller 304 includes a processor (not shown) that facilitates data communication between each gaming machine 100 within each bank 302, and between each gaming machine 100 and other components of gaming network 300. In one embodiment, each bank controller 304 also includes audio capabilities, such as a CD-ROM drive (not shown) or DVD-ROM drive (not shown), that are coupled to a sound card (not shown) for processing and transmitting digitized sound effects to one or more speakers 306 in response to commands issued over gaming network 300 by bank controller 304. Each bank controller 304 is also coupled via gaming network 300 to an electronic sign or screen 308 that displays information, such as via scrolling and/or flashing messages that indicate, for example, jackpot amounts, and that are visible to players playing gaming machines 100. Messages for display on each electronic screen 308 are generated and/or modified in response to commands issued over gaming network 300 by bank controller 304.

As described above, gaming machines 100 may include video poker machines, video slot machines, and/or other similar gaming machines that implement alternative games. Moreover, gaming machines 100 may be terminal-based machines, wherein the actual games, including random number generation and/or outcome determination, are performed at a remote gaming server 310. In such an embodiment, the gaming machine 100 displays results of the game played on gaming server 310 via video display monitor 118 (shown in FIG. 1 above).

A network connector, such as an Ethernet hub 312, couples each bank controller 304 to a concentrator 314. Concentrator 314 functions as a data control switch that routes data from each bank 302 to a translator 316. Translator 316 provides a compatibility buffer (not shown) between concentrator 314 and an accounting system 318. Moreover, translator 316 translates data gathered from each bank 302 into a format that is compatible with accounting system 318. A progressive controller 315 controls, monitors, or otherwise manages progressive games.

Another Ethernet hub 320 couples concentrator 314 to a configuration workstation 322, a player server 324, and to one or more bonus servers 326. Configuration workstation 322 includes a user interface that enables an administrator to set up and/or to modify portions of gaming network 300 and/or servers 310, 324, and 326. Player server 324 tracks data of players using gaming machines 100. Player server 324 also controls messages that appear on each video display monitor 118 and/or information panel 120 of gaming machines 100. In the exemplary embodiment, player server 324 also stores physical characteristics of players, such as the player age and/or vision data. Bonus server 326 controls bonus applications or bonus systems on gaming network 300. Bonus server 326 includes a set of rules for awarding jackpots in excess of those established by winning pay tables (not shown) of each gaming machine 100. Some bonus awards may be awarded randomly, while other bonus awards may be made to groups of gaming machines 100 operating in a progressive jackpot mode.

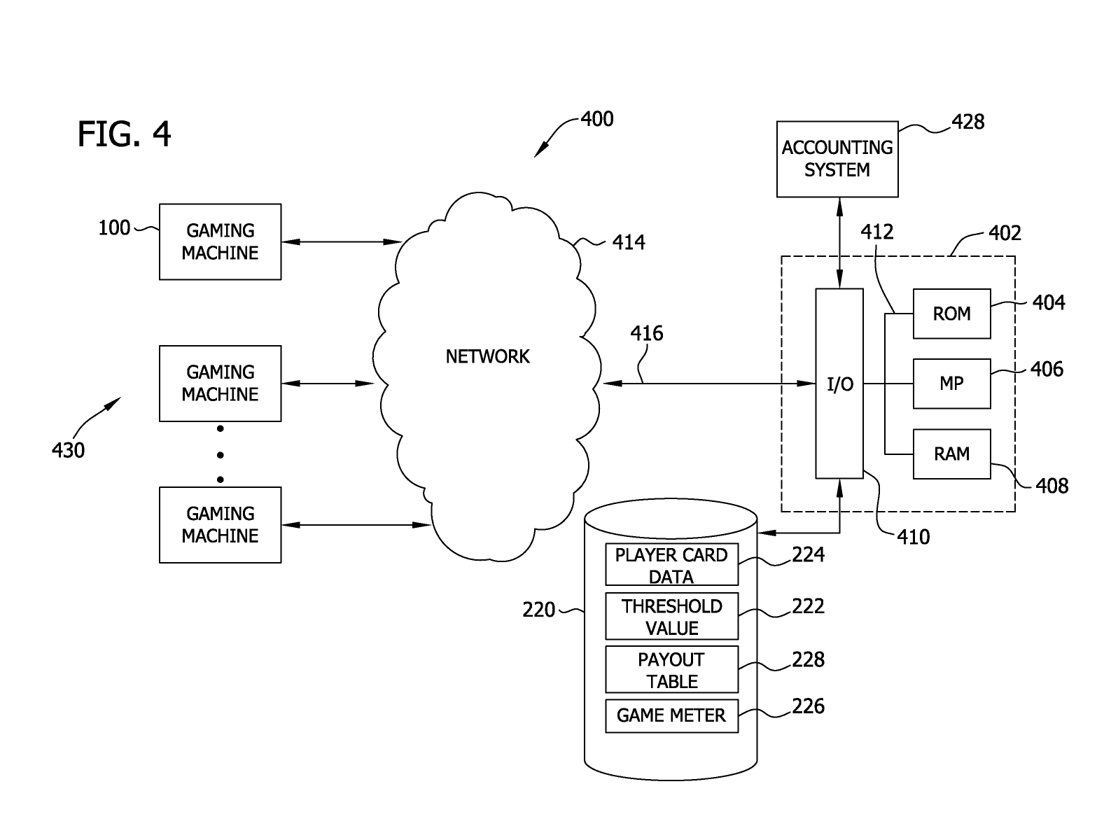

Referring now to FIG. 4, in one embodiment, an exemplary block diagram illustrates a gaming network 400 that includes a plurality of gaming machines 100. In the exemplary embodiment, gaming machine 100 includes a gaming network controller 402 that includes a read-only memory (ROM) 404, a microcontroller or microprocessor (MP) 406, a random-access memory (RAM) 408, and an input/output (I/O) circuit 410, each coupled via an address/data bus 412. As used herein, the terms “controller” and “processor” may include any programmable system including systems using microcontrollers, reduced instruction set circuits (RISC), application specific integrated circuits (ASICs), logic circuits, and any other circuit or processor capable of executing the functions described herein.

The above examples are exemplary only, and are thus not intended to limit in any way the definition and/or meaning of the terms “controller” or “processor”. Alternative embodiments of gaming network controller 402 may include more than one microprocessor 406, multiple RAM modules 408, and/or multiple ROM modules 404. Moreover, although I/O circuit 410 is shown in FIG. 4 as a single component, one of ordinary skill in the art will appreciate that I/O circuit 410 may include any number or a plurality of different types of I/O circuits. Further, RAM 408 and/or ROM 404 may be implemented as, for example, semiconductor memories, magnetically readable memories, and/or optically readable memories. In one embodiment, each operational component of gaming machine 100 is coupled to l/O circuit 410 via a network 414. The network may be of any type and use any protocol such as, for example, the Internet, Ethernet, Local Area Network, Wide Area Network, Private Network, Bluetooth, WIFI, WiMAX, etc.

Alternative embodiments may include a single coupling between the operational components of gaming machine 100 and I/O circuit 410. In the exemplary embodiment, I/O circuit 410 is coupled to the network 414 via a network interface 416. Moreover, in the exemplary embodiment, gaming server 400 includes a memory area 220. The memory area 220 is configured to store information about each of the plurality of gaming machines comprising the gaming network, the information stored may be, for example, player card info 224 including, but not limited to, player specific data from a player's card and game machine associated with player, at least one threshold value 222, one or more payout tables 228, at least one game meter 226, and any other data the operator programs the gaming network controller 402 to store. The gaming network controller 402 is further coupled to an accounting system 428, the accounting system, 428 is configured to store information such as, for example, a player's data, a payout associated with the player, and any other information the accounting system 428 is programmed to receive and store.

Gaming network controller 402 is coupled to the network 414 via a network interface 416. In this example of FIG. 4, three 430 gaming machines 100 coupled to the network 414 via network interface 214.

In an exemplary embodiment, the gaming network controller 402 displays video images to the video display monitor 118 of gaming machine 100. Gaming network controller 402 receives input from the user at the value input interface 230 of gaming machine 100; the gaming network controller 402 may display to the player a request to input a wager amount and/or amounts of a wager to choose. The player selects the wager amount using the keypad 136 or any other mechanism to indicate a selection.

The threshold value 222 and/or progressive flag associated with the payout tables 228 stored in the memory area 220. A game is displayed at the video display monitor 118 controlled by the gaming network controller 402. The gaming network controller 402 determines an outcome and based at least partially on the wager determines a payout based on the payout tables 228 stored in the memory area 220.

The example for determining payout options when the determined payout value exceeds the threshold is described with reference to Tables 1, 2, and 3 above are applicable in the network based embodiment described in FIG. 4.

The gaming network controller 402 routes player information and payout information to the accounting system 428. The accounting system 428 stores accounting information for each payout including, but not limited to, player's name, address, and social security number, payout value, and payout option chosen.

The embodiments illustrated and described herein as well as embodiments not specifically described herein but within the scope of aspects of the invention constitute exemplary means for determining a payout value based on a progressive interrupt flag associated with a payout table. For example, the gaming network controller in FIG. 4 constitutes exemplary means for determining a payout value based on a progressive interrupt flag associated with a payout table.

The embodiments illustrated and described herein as well as embodiments not specifically described herein but within the scope of aspects of the invention constitute exemplary means for altering the payout value associated with the gaming machine associated with the determined status of the number of wins for of the gaming machines. For example, the gaming network controller in FIG. 4 constitutes exemplary means for altering the payout value associated with the gaming machine associated with the determined status of the number of wins for of the gaming machines.

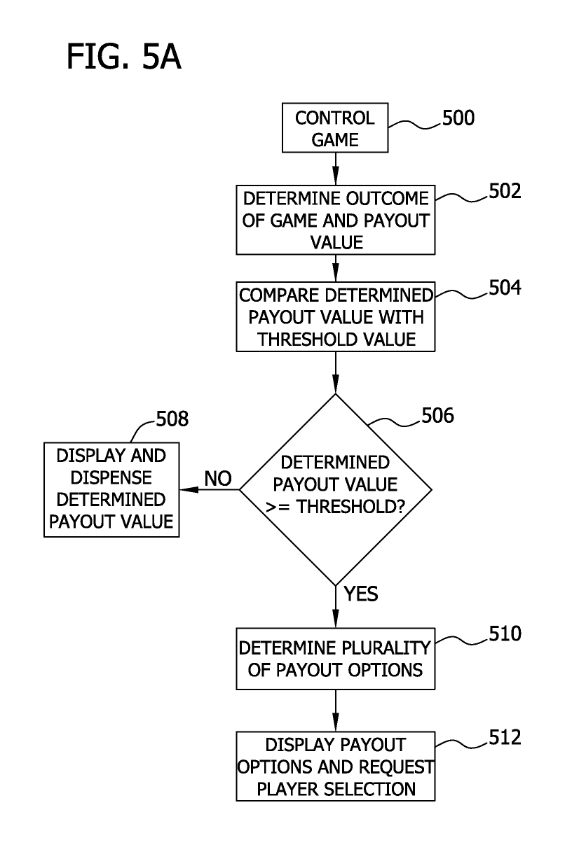

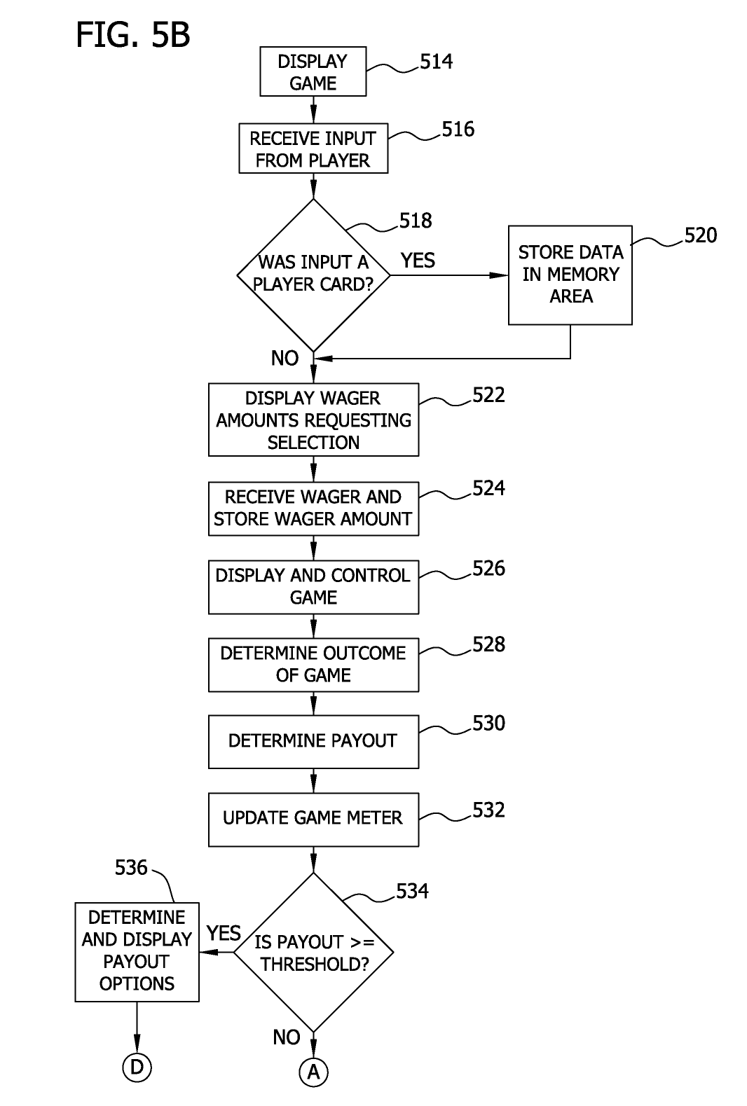

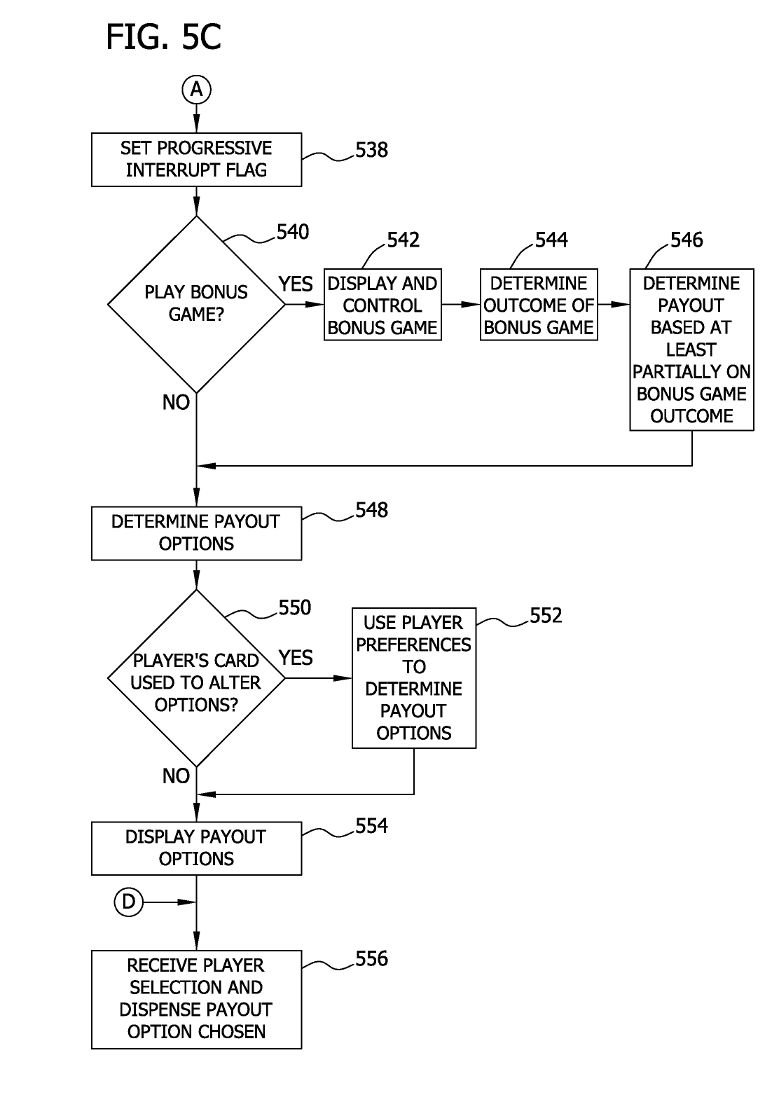

Referring now to FIGS. 5A, 5B and 5C, exemplary flowcharts illustrate methods for determining, at a gaming machine controller 202, a plurality of payout values for an outcome of a game at a gaming machine 100.

At 500 of FIG. 5A, game machine controller 202 controls the game being displayed at the video display monitor 118 of gaming machine 100. At 502, gaming machine controller 202 determines an outcome of the game being displayed and determines a payout value associated with the outcome of the game. At 504, gaming machine controller 202 compares the determined payout value with the threshold value 222 assigned to the gaming machine 100, which can be communicated by a flag. At 506, if the determined payout value is less than the assigned the threshold value 222, then at 508 the determined payout value is displayed and dispensed to the player. At 506, if the determined payout value is greater than or equal to the assigned the threshold value 222, then at 510 the game machine controller 202 determines a plurality of payout options. At 512, the game machine controller 202 displays the payout options at the video display monitor 118 and request the player to select at least one of the plurality of payout options.

At 514 of FIG. 5B, a gaming machine controller 202 controls a video and/or audio display at the video display monitor 118. At 516, a player inputs a wager, player's card, debit card, credit card, tokens, etc. at the value input interface at gaming machine 100. At 518, gaming machine controller 202 determines if the input by the player was a player's card. At 520, if the input was a player's card the player's card data is stored in the memory area. At 522, the gaming machine controller 202 requests the player to select the amount of wager for a game. At 524, the computing device receives the wager from the player and stores the amount of the wager at the memory area 220.

At 526, the gaming machine controller 202 displays and controls the game. At 528, the gaming machine controller 202 determines the outcome and displays the game to the player at the video display monitor 118 of the gaming machine 100. At 530, the gaming machine controller 202 determines the payout of the game based at least partially on the wager and the outcome of the game. The payout may further be determined based on data contained on the player's card if one has been input by the player and/or the payout tables 228. At 532, the gaming machine controller 202 updates the number of wins in the memory area 220 of the gaming machine 100.

At 534, the gaming machine controller 202 determines if the payout is equal to or greater than the threshold value 222. At 536, if the determined payout is less than the threshold value 222 the gaming machine controller 202 determines payout options and displays the payout options to the player at the video display monitor 118.

At 538 of FIG. 5C, the gaming machine controller 202 sets a progressive flag to be used in association with the payout tables 228 stored in the memory area. At 540, the gaming machine controller 202 determines if a bonus game is to be played. At 542, if a bonus game is to be played, the gaming machine controller 202 displays and controls the video of the bonus game at the video display monitor 118 of the gaming machine 100. At 544, the gaming machine controller 202 determines the outcome of the bonus game. At 546, the gaming machine controller 202 alters the payout based at least partially on the outcome of the bonus game.

At 548, the gaming machine controller 202 or remote gaming server 310 (or other remote server controlling play on the gaming machine 100) determines a plurality of payout options, where at least one of the determined payout options has a cash payout less than the threshold value 222 stored in the memory area 220. At 550, gaming machine controller 202 determines if player's card data indicates payout preferences. At 552, if data from the player's card indicates payout option preferences, the gaming machine controller 202 alters the plurality of payout options.

At 554, the gaming machine controller 202 displays the plurality of payout options to the player at the gaming machine 100. At 556, once the player has selected a particular payout option, the gaming machine controller 202 the computing device outputs the selected payout option to the player. The selected payout option may also be stored on the player's card if one was inserted at block 516 of FIG. 5B. Alternatively, the payout is controlled by the remote gaming server 310 or other server controlling play on the gaming machine 100, in server-based embodiments.

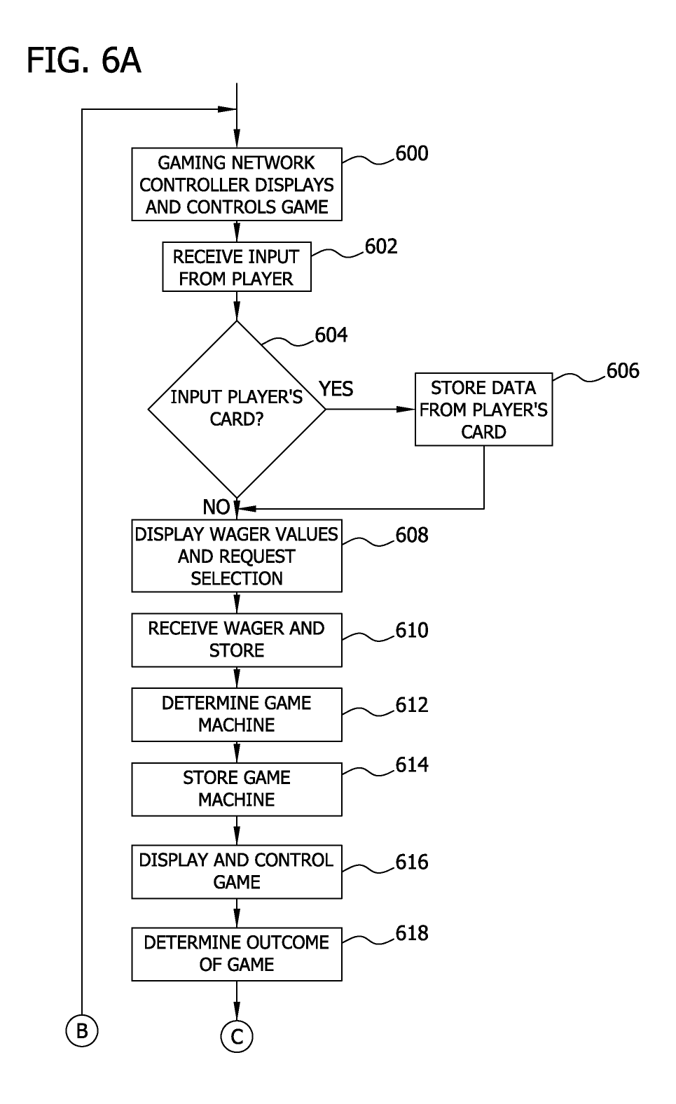

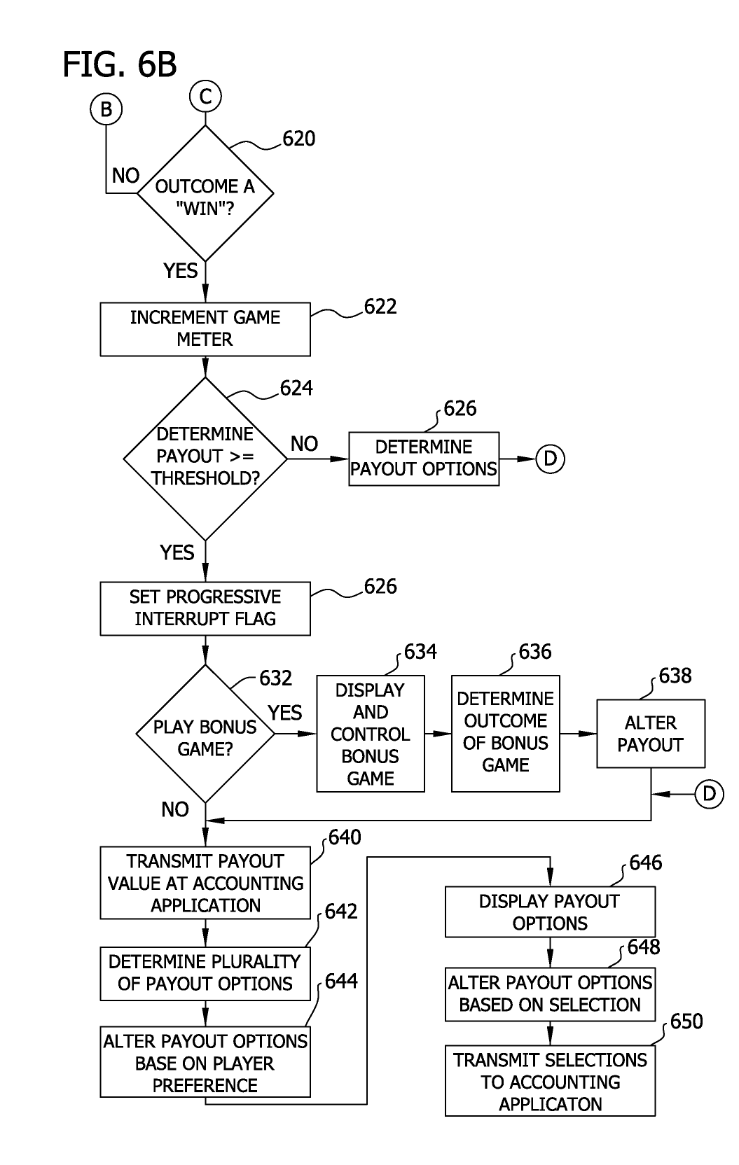

Referring to FIGS. 6A and 6B, exemplary flowcharts illustrate methods for determining a plurality of payout options and altering the payout options based on the payout option chosen in a gaming network 400. At 600 of FIG. 6A, the gaming network controller 402 controls a video and/or audio display at the video display monitor 118. At 602, a player inputs a wager, player's card, debit card, credit card, tokens, etc. at the value input interface at the gaming machine 100. At 604, the gaming network controller 402 determines if the input by the player was a player's card. At 606, if the input was a player's card the player's card data is stored in the player's card data 224 of the memory area 220. At 608, the gaming network controller 402 requests the player to select the amount of wager for a game. At 610, the gaming network controller 402 receives the wager from the player and stores the amount of the wager at the memory area 220. At 612, the gaming network controller 402 determines the game machine 100 associated with the player. At 614, the gaming network controller 402 stores the gaming machine 100 associated with the player in the memory area 220. At 616, the gaming network controller 402 displays and controls the game selected by the player. At 618, the gaming network controller 402 determines the outcome of the game at the gaming machine 100.

At 620 of FIG. 6B, if the outcome of the game is a “WIN”, then at 622 the number of wins for the gaming machine 100 is incremented in the game meter 226 stored in the memory area 220 At 624 the determined payout is compared with the stored the threshold value 222. At 626, if the determined payout is less than the stored the threshold value 222 the gaming network controller 402 determines payout options and control proceeds to block 640, which is described below.

At 630, if a bonus game is not to be played, the gaming network controller 402 determines the payout of the game based at least partially on the wager and the outcome of the game. The payout may further be determined based on data contained on the player's card data stored in the player's card data 224 of the memory area 220.

At 632, the gaming network controller 402 determines if a bonus game is to be played. At 634, if a bonus game is to be played, the gaming network controller 402 displays and controls the video of the bonus game at the video display monitor 118 of the gaming machine 100. At 636, the gaming network controller 402 determines the outcome of the bonus game. At 638, the gaming network controller 402 alters the payout based on at least one of: the outcome of the bonus game, the number of wins associated with the gaming machine 100, data contained on the player's card, wager, and the progressive flag.

At 640, if the determined payout is equal to or greater than the threshold value 222 stored in the memory area 220, stores payout exceeds the threshold value 222 in the memory area 220. At 642, the gaming network controller 402 determines a plurality of payout options, where at least one of the determined payout options has a cash payout less than the threshold value 222 stored in the memory area 220. At 644, the gaming network controller 402 may alter the plurality of payout options based on data stored on the player's card.

At 646, the gaming network controller 402 displays the plurality of payout options to the player at the video display monitor 118 of the gaming machine 100. At 648, the gaming network controller 402 alters the payout options based on the selection by the player. At 650, once the player has selected a particular payout option, the gaming network controller 402 updates the accounting system with player information and payout option chosen.

The order of execution or performance of the operations in embodiments of the invention illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

A computing device or computer such as described herein has one or more processors or processing units and a system memory. The computer typically has at least some form of computer readable media. By way of example and not limitation, computer readable media comprise computer storage media and communication media. Computer storage media include volatile and nonvolatile, removable and non-removable media implemented in any method or technology for storage of information such as computer readable instructions, data structures, program modules, or other data. Communication media typically embody computer readable instructions, data structures, pro gram modules, or other data in a modulated data signal such as a carrier wave or other transport mechanism and include any information delivery media. Those skilled in the art are familiar with the modulated data signal, which has one or more of its characteristics set or changed in such a manner as to encode information in the signal. Combinations of any of the above are also included within the scope of computer readable media.

Although described in connection with an exemplary computing system environment, embodiments of the invention are operational with numerous other general purpose or special purpose computing system environments or configurations. The computing system environment is not intended to suggest any limitation as to the scope of use or functionality of any aspect of the invention. Moreover, the computing system environment should not be interpreted as having any dependency or requirement relating to any one or combination of components illustrated in the exemplary operating environment. Examples of well known computing systems, environments, and/or configurations that may be suitable for use with aspects of the invention include, but are not limited to, personal computers, server computers, hand-held or laptop devices, multiprocessor systems, microprocessor-based systems, set top boxes, programmable consumer electronics, mobile telephones, network PCs, minicomputers, mainframe computers, distributed computing environments that include any of the above systems or devices, and the like.

Embodiments of the invention may be described in the general context of computer-executable instructions, such as program modules, executed by one or more computers or other devices. Aspects of the invention may be implemented with any number and organization of components or modules. For example, aspects of the invention are not limited to the specific computer-executable instructions or the specific components or modules illustrated in the figures and described herein. Other embodiments of the invention may include different computer-executable instructions or components having more or less functionality than illustrated and described herein.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of aspects of the invention as defined in the appended claims. As various changes could be made in the above constructions, products, and methods without departing from the scope of aspects of the invention, it is intended that all matter contained in the above description and shown in the accompanying drawings shall be interpreted as illustrative and not in a limiting sense.

What is claimed is:

1. A gaming apparatus comprising:
a display for providing game images to a player;
a value input interface for receiving a wager from the player;
a memory area for storing a threshold value; and
a controller coupled to the display, the value input interface and the memory area, said controller programmed to:
control a game for display to the player on the display;
determine a payout value associated with an outcome of the game, wherein the payout value is based at least partially on the wager received by the value input interface;
compare the determined payout value with the threshold value stored in the memory area; and
determine a plurality of payment options based on the comparison, wherein at least one of the determined plurality of payment options has a cash payout value less than the threshold value.

2. The gaming apparatus of claim 1, wherein the display comprises at least one of the following: a cathode ray tube, touch screen display, light emitting diode display, liquid crystal display, reels, dice, tiles, and balls.

3. The gaming apparatus of claim 1, wherein the wager is conveyed by one or more of the following: credit card, debit card, smart card, game card, tokens, coins, paper receipt, paper money and player's card.

4. The gaming apparatus of claim 1, wherein the controller is further programmed to receive data from a player's card associated with the player.

5. The gaming apparatus of claim 4, wherein the threshold value is determined at least partially by data stored on the player's card.

6. The gaming apparatus of claim 4, wherein the at least one of the plurality of payment options is determined by at least partially data stored on the player's card.

7. The gaming apparatus of claim 4, wherein the payout value is determined by at least partially data stored on the player's card.

8. The gaming apparatus of claim 1, wherein the plurality of payment options include one or more of the following: merchandise, airfare, credits, accommodations, game credits and game coins.

9. The gaming apparatus of claim 1, wherein the memory area further stores a payout table comprising a plurality of payout values and further comprising associating one or more of payout values with a progressive interrupt flag as a function of the.

10. The gaming apparatus of claim 1, wherein the threshold value represents a taxable value.

11. The gaming apparatus of claim 1, wherein the controller is further programmed to control a bonus game responsive to the determined payout value, wherein an outcome of the bonus game alters the payout value.

12. The gaming apparatus of claim 1, wherein the controller is further programmed to display the determined plurality of payment options on the display, and receive a selection from the player of at least one of the displayed plurality of payment options.

13. The gaming apparatus of claim 1, wherein the controller is further programmed to display the determined plurality of payment options in at least one of the following formats: graphical and textual.

14. A gaming system, comprising:
a plurality of gaming machines coupled to a network;
a controller coupled to the network, said controller programmed to:
control one or more games for display on one or more of the plurality of gaming machines;
determine outcomes for the controlled games;
identify one or more of the determined outcomes having a payout value exceeding a predefined threshold corresponding to the game;
determine a plurality of payout options for each of the identified one or more outcomes, wherein at least one of the plurality of payout options for each of the identified one or more outcomes has a cash payout less than the defined threshold; and
provide the determined plurality of payout options to each of the gaming machines corresponding to the identified one or more outcomes.

15. The gaming system of claim 14, further comprising:
an accounting system coupled to the controller, wherein the accounting system is configured to receive player information, and wherein the controller determines the plurality of payout options based at least partially on the player information.

16. The gaming system of claim 14, wherein the controller alters the payout value based on the determined value of payout options.

17. The gaming system of claim 14 further comprising a memory area associated with the controller, said memory area identifying payout values that exceed the predefined threshold for each of the games.

18. The gaming system of claim 14, wherein the controller is further configured to provide a bonus game, wherein an outcome of the bonus game on each of the gaming machines alters the payout value associated with the gaming machine.

19. The gaming system of claim 14, wherein the controller is further configured to provide a bonus game comprising a means for determining a payout value based on a progressive interrupt flag associated with the payout table for each of the gaming machines.

20. The gaming system of claim 19, wherein the controller is further configured to provide a bonus game comprising a means for altering the payout value associated with the gaming machine associated with the determined status of the number of wins for each of the gaming machines.

21. A method for providing a plurality of payout options in a gaming apparatus, the method comprising:
defining a threshold cash payout value for a game;
controlling a session of the game for a player, wherein said controlling generates a payout value associated with the session;
comparing the generated payout value to the defined threshold cash payout value;
determining the plurality of payout options for the session as a function of said comparing, wherein the determined plurality of payout options includes at least one non-cash payout option;
presenting the determined plurality of payout options to the player;
receiving a selection of at least one of the presented plurality of payout options from the player; and
altering the generated payout value based on the received selection.

22. The method of claim 21, wherein altering the generated payout value comprises reducing the payout value corresponding to a value associated with the received selection.

23. The method of claim 21, further comprising
providing for a bonus game displayed to the player based on the payout value of the outcome of the game, wherein altering the payout value as a function of the bonus game.

24. The method of claim 21, wherein controlling the session comprises controlling the session on a gaming machine, and wherein presenting the determined plurality of payout options to the player comprises providing the determined plurality of payout options to the gaming machine for display to the player.

25. The method of claim 21, wherein the wager is conveyed by one or more of the following: credit card, debit card, smart card, game card, tokens, coins, paper receipt, paper money and player's card.

26. The method of claim 21, wherein the wager is conveyed by a player's card inserted by the player.

27. The method of claim 21, further comprising:
storing a payout table, the payout table comprises a plurality of payout values and further comprising marking the payout values with a progressive interrupt flag associated with the payout table as a function of the threshold value.

28. The method of claim 27, wherein determining the plurality of payout options comprises accessing a secondary payout table based on the progressive interrupt flag.

29. The method of claim 21 further comprising providing for a bonus game displayed to the player based on the payout value of the outcome of the game, wherein altering the payout value as a function of the bonus game.

30. The method of claim 29, wherein displaying the determined plurality of payment options in at least one of the following formats: graphical and textual.
